(19) United States
(12) Patent Application Publication
(10) Pub. No.: US 2024/0421320 A1
(43) Pub. Date: Dec. 19, 2024

(54) LITHIUM METAL ELECTRODE, METHOD OF MANUFACTURING A LITHIUM ION ELECTRODE AND LITHIUM ION BATTERY

(71) Applicant: MAX-PLANCK-GESELLSCHAFT ZUR FÖRDERUNG DER WISSENSCHAFTEN E.V., München (DE)

(72) Inventors: Timotheus JAHNKE, Stuttgart (DE); Yuanzhen WANG, Böblingen (DE); Joachim SPATZ, Stuttgart (DE)

(21) Appl. No.: 18/708,296

(22) PCT Filed: Dec. 7, 2021
(86) PCT No.: PCT/EP2021/084641

§ 371 Date: May 8, 2024

(51) Int. Cl. H01M 4/66; H01M 4/02; H01M 4/04; H01M 4/134; H01M 4/1395; H01M 4/38; H01M 4/70; H01M 10/0525

(52) U.S. Cl. CPC H01M 4/662; H01M 4/0404; H01M 4/043; H01M 4/045; H01M 4/134; H01M 4/1395; H01M 4/382; H01M 4/667; H01M 4/70; H01M 10/0525; H01M 2004/021; H01M 2004/027; H01M 2220/20

(57) ABSTRACT

The present invention concerns a lithium metal electrode, in particular for a lithium ion battery, comprising a three-dimensional network of metal fibers, wherein the metal fibers are directly in contact to one another, wherein the metal fibers have a thickness and/or width in the range of 0.25 to 200 μm, and wherein metallic lithium is provided on the surface of the metal fibers of the tree-dimensional network of metal fibers. Further, the present invention concerns a Method of manufacturing a lithium metal electrode, wherein the method comprises the steps of a) providing a three-dimensional network of metal fibers, wherein the metal fibers are directly in contact to one another, wherein the metal fibers have a thickness and/or width in the range of 0.25 to 200 μm; and b) providing a layer of metallic lithium on the fibers of the three-dimensional network of metal fibers.

The present invention relates to a lithium metal electrode, in particular an anode, for a lithium ion battery. Further, the present invention relates to a method of manufacturing a lithium metal electrode and to a battery comprising such an electrode.

Lithium metal anodes for lithium ion batteries have been in discussion since the 70^{th} of the last century, due to their high capacity. Typical anodes for lithium ion batteries utilize an active material in which the lithium is embedded. In contrast, lithium metal anodes do not include such an active material. Instead, the metallic lithium is deposited onto a template.¹⁻³ However, the high reactivity of lithium and its tendency to form dendrites impeded the application of pure lithium in an electrode. Such dendrites grow until they perforate the separator leading to an internal short circuit.¹ This was overcome by the discovery of graphite as lithium host by Akira Yoshino in 1985 for which he was awarded the Nobel Prize for Chemistry in 2020 together with Stanley Whittingham and John Goodenough.⁴

In recent years the idea of using pure metallic lithium instead of graphite is attracting anew a wealth of attention due to the enormous boost in capacity since metallic lithium has a significantly higher theoretical capacity of 3800 mAh/g compared to 372 mAh/g for graphite based electrodes. Different strategies have been proposed to impede lithium dendrite growth and the associated formation of dead lithium. These strategies include the formation of dense 3-dimensional (3D) anode structures,⁵⁻¹¹ electrolyte engineering^{12,13}, electrode surface modification¹⁴ or tailored separators. 15 It is believed by the inventors that for overcoming the effect of dendrite growth and the associated formation of dead lithium, the lithium needs to be deposited in a dense layer or structure which offers large surface area for lithium to be deposited.

Especially the 3D scaffold structures used for lithium deposition have been in the focus of research, since these porous structures offer sufficient free volume for the volume changes associated with the deposition and stripping process.

Additionally, due to the high conductivity of these hosts a homogeneous potential and as such a homogeneous lithium deposition along the scaffolds surface is assured. Such scaffolds can be distinguished into carbon-based scaffolds and metallic scaffolds. For both, carbon-based scaffolds and metallic scaffolds it is in principle possible to use foam-based structures or fiber-based structures.

Carbon-based scaffolds as such usually unify a low weight with a good electrical conductivity and can be fabricated as free-standing electrode.^{16,17} Such carbon-based structures involve the application of carbon-nanotubes, graphene or graphitic fibers; however, they have significant drawbacks when applying them in a lithium metal based anode. When the electrode is composed of a free-standing carbon-based electrode, its transition into the outer metallic circuit is a large hindrance. The mechanical and electrical connection between the carbon electrode and the outer metallic circuit is problematic, since welding is not possible and as such its mechanically instable and electrically large resistances appear. In order to improve the connection, highly conductive binders (e.g. metallic lacquers) have been applied, but this idea was soon abandoned, due to a large temperature-rise at the interconnection during charging/discharging the cells.

To summarize, the processability of carbon-based materials after they have acquired their final hierarchical structure in the electrode is difficult, which prevents the application of common processing steps (e.g. soldering, welding).

On the other hand, metal structures possess superior conductivity and mechanical and electrochemical stability, but have a high density. Such metal scaffold can be applied in the form of a 3-dimensional foam or a fibrous network. Especially a foam is known to be used in the ranges of 90-95% porosity and a metal strand diameter of 30-100 μm.^{14,16} Usually, an open porosity of the foams ensures the continuous lithium deposition on the scaffold, which can further be improved by surface modification. 14,18 Studies on copper foam were able to show, that during the lithium deposition into a metallic foam a large amount of “dead lithium” is formed, which is not partaking in the electrochemical reaction. Thus, the effectivity of such foam-type electrodes is severely limited as shown be Lin et al. (Supporting Information).¹⁸

In case of the investigation of fibrous network, only two different techniques separated by scale of the fiber strand diameter are known.

The first is the formation of a network made from metal strands with thicknesses in the range of 50 μm or larger, typically of 1 mm or larger, forming a mesh-like network structure. This mesh then can be modified to improve the lithium deposition behavior, but usually has the drawback that the volume to surface ratio is low and consequently leads to a decrease in gravimetric energy density on the whole electrode. A known lithium-metal anode is described by Li, Q., Zhu, S., Lu, Y., “3D Porous Cu Current Collector/Li-Metal Composite Anode for Stable Lithium-Metal Batteries” Adv. Funct. Mater. 2017, 27, 1606422.

The second approach is based on a wet chemical process, which is used to fabricate Cu-Nanowires with a diameter of up to 200 nm. An alkaline reaction agent is used to deposit Cu(OH)₂ in the form of nanowhiskers, which then are reduced either thermally in forming gas (AR/H2 or pure H2) or chemically with hydrazine for example to metallic copper.^{19,20} The resulting fibers are usually very well defined in thickness (50-200 nm) and have characteristically large aspect ratios. Thicker fibers in the range of 0.5 to 50 micron cannot be fabricated using the beforementioned techniques, since whisker growth is limited to a high aspect ratio, and copper fibers cannot be drawn smaller than 20 micron using conventional methods of drawing metal fibers.

In view of this, there is a need to provide lithium metal electrodes, in particular for a lithium ion battery, which avoids the formation of dendrites and dead lithium and reduces electrochemical stress during operation of a corresponding battery.

According to the present invention, this object is solved by an electrode according to claim 1. In particular, this object is solved by a Lithium metal electrode, in particular for a lithium ion battery, comprising a three-dimensional network of metal fibers, wherein the metal fibers are directly in contact to one another, wherein the metal fibers have a thickness and/or width in the range of 0.25 to 200 μm, and wherein metallic lithium is provided on the surface of the metal fibers of the tree-dimensional network of metal fibers.

It was found that with the lithium metal electrode of the present invention the formation of dendrites even after a repeated number of cycles is suppressed, so that the lifetime of a corresponding battery is significantly increased. Further, in contrast to foam material, no formation of dead lithium is observable, allowing for a high efficiency in the range between 90 and 100 percent, a high areal and weight specific capacity for such an electrode. In comparison, foam like electrodes provide much lower efficiencies compared to the metal fiber network based electrodes of the present invention. Without being bound by a theory, it is assumed that the growth of dendrites is suppressed by the large surface area provided by metal fibers having a thickness in the range of 0.25 to 200 μm. The large surface area leads to a lower deposition rate per areal unit of the electrode, for a given current.

Moreover, the three-dimensional network structure does not only have an influence on the overall cyclic performance of the electrode, but also on the deposition mechanism and the related overpotential. The potential at which lithium deposition occurs in an electrochemical cell is usually given by the intercalation voltage of an electrode, e.g. for graphite between 0.1 V and 0.4 V or for LiNiMnCoO2 (NMC) between 3.5 V and 4 V. However, since the intercalation rate is limited, meaning that only a certain number of Li-ion can be intercalation into a certain volume of active material in a given time frame, higher charging rates lead to overpotentials. Not only are these overpotential observed during different charging rates, but also because of ageing of the electrolyte. In this case the decomposition of the electrolyte, due to the higher applied voltages, leads to the growth of the solid electrolyte interface (SEI), which decreases the speed at which the Li-Ions are transported to the active material drastically. Thus, the overpotential measured during a constant charge/discharge profile is also a method to evaluate the electrochemical stress enacting upon the electrode. Further, the overpotential (and its energy, given by current multiplied by voltage) is directly converted into heat and lost during the storage process, lower overpotentials are highly beneficial. It was observed that the three-dimensional electrodes of the present invention have a lower overpotential compared to 2D-electrodes already during the first cycle. Measurement has shown that after 50 cycles the overpotential observed for 2D-electrodes increases significantly, whereas the three-dimensional electrodes of the present invention demonstrate almost no change regarding their overpotential even after 50 cycles. Accordingly, the electrode of the present invention not only suppresses the formation of dendrites, but also reduces the electrochemical stress occurring during the operation of a corresponding battery.

In summary, the lithium metal electrode of the present invention is able to improve life time and the capacity of a corresponding lithium metal based full cell. Additionally, the heat formation during the charging/discharging process is highly related to the overpotentials applied during the respective process. This means, that faster charging leads to more heat and older cells generally produce also more heat. This effect could be highly decreased by using a lithium metal electrode according to the present invention. Especially during the metal stripping process, the observed overpotential is significantly lower compared to a corresponding 2D-electrode.

In the following aspects of the present invention are described in detail, which are to be considered each as such, but also in any conceivable combination with one another.

In accordance with the present invention, it is preferable that the electrode is essentially free of carbon-based materials. By using metal fibers for the electrode, it is possible to sinter the metal fibers directly to one another, so that electrically conductive points of contact are formed between these metal fibers. The use of further carbon-based materials as binder for the metal fibers and/or as electrode active material, is unnecessary. By avoiding the presence of such carbon-based materials, the electrode can achieve a capacity closer to the theoretical capacity of 3800 mAh/g.

Preferably the metal fibers are in direct electrical contact with one another such that the electrical conductivity can be enhanced to a maximum. In accordance with the present invention, the metal fibers are preferably directly sintered to one another at points of contact between the metal fibers. In this regard it is particularly preferable that all of the metal fibers are sintered to other metal fibers, most preferable directly to other metal fibers, without the need of an additional binder, e.g. a polymeric binder or solder. It is therefore further preferred that the metal fibers are fixed to one another without a polymeric binder, since such polymeric binders often have a poor electrical conductivity and high temperature performance.

Preferably, the metal fibers are of copper, nickel, tin, a copper alloy, or a nickel alloy, more preferably of copper or a copper alloy. Such metal fibers exhibit very high electric conductivity allowing for a very low internal resistance. Furthermore, by metal fibers of copper or a copper alloy, an enhanced metal-metal surface diffusivity can be exploited. Without being bound to a theory, in the lithium metal electrode of the present invention a metal fiber-based, in particular sintered, network acts as backbone for the active material, which is lithium metal according to the present invention. This enables both excellent transport of the electrical energy from the intercalation site to the current collector, whilst providing a large effective diffusion Deff in the electrolyte. Even with an unordered network of metal fibers, always at least a portion of the fibers' orientation is parallel to the ion flux, thus the surface diffusion phenomenon enhances the ion flow within the electrodes. At high charging rates, the concentration gradient in the liquid is smaller, due to the enhanced surface properties of the metal fiber based network. The surface diffusion leads to more ions transported from the source (Li) to the “consumer” (Network). This effect significantly improves the overall performance and may be an explanation for the observed low overpotentials. The improved surface diffusivity is beneficial even for lower thicknesses of the electrodes. Nevertheless, it is noted that the effect is even more pronounced for thicker electrodes, especially for electrodes having a thickness in the range of equal to or greater than 100 μm.

It is further preferred that the metal fibers are of a copper alloy, consisting essentially of copper and at least a further element, selected from the group consisting of zinc, boron, aluminum, gallium, indium, thallium, silicon, germanium, tin, lead, arsenic, antimony, bismuth, selenium, and tellurium, in particular from the group consisting of zinc, boron, silicon, germanium, tin, arsenic, antimony, and tellurium. More preferably, the copper alloy consists essentially of copper and silicon. Particularly suitable copper alloys are CuSi8 or CuSi4. It is easier to produce metal fibers of copper alloys by melt spinning, compared to metal fibers of pure copper. Especially for obtaining fibers in a metastable state, showing an exothermic event when heated in a DSC measurement, it is easier to use a copper alloy instead of pure copper. As explained in the following, such a metastable state of the initial fibers may result in a stronger network of metal fibers.

Not only is the interaction between the metal fiber surface and the metallic lithium a crucial parameter during the charging/discharging process, but also the lithiophilicity or -phobicity of the network needs to be considered. Hereby, the addition of silicon in the cuprous network is able to improve the performance of the network greatly. To the inventor's knowledge, this effect of silicon as an additive has not been reported beforehand, however, measurements on pure silicon showed slight enhancement of the diffusion kinetics.^{21,22}

Alloying cooper with silicon, in particular with small amounts of silicon (<20 wt %), seems to enhance the deposition of lithium on the fiber surface and improves the cycling stability of electrodes. As a result, the resulting electrode is much less prone to dendrite formation as copper foil or copper foam and less to no formation of dead lithium is observed. In view of this it is preferable that the metal fibers are of a copper alloy, comprising copper and less than 20 wt. % of silicon, in particular less than 15 wt. % of silicon, even more preferably, consisting essentially of copper and less than 20 wt. % of silicon, in particular less than 15 wt. %, of silicon, further more preferably consisting of copper and less than 20 wt. % of silicon, in particular less than 15 wt. % of silicon. Regarding the effect of improving deposition of lithium and cycling stability of the electrodes, the amount of silicon in the copper alloy is preferably 0.05 wt. % or more, and more preferably 0.1 wt. % or more. Particularly suitable examples are copper alloys consisting of copper and 0.1 wt. % to 15 wt. % of silicon and optionally further elements.

The fibers can be sintered to one another, as described for example in WO 2020/016240 A1

In accordance with the present invention, it is preferable that the metal fibers, before fixing them one to another, show an exothermic event when heated in a DSC measurement, wherein the exothermic event releases energy in an amount of 0.1 KJ/g or more, more preferably in an amount of 0.5 KJ/g or more, even more preferably in an amount of 1.0 KJ/g or more and most preferably in an amount of 1.5 KJ/g or more. The absolute amounts depend very much on the used metal or metal alloy. The extent of the exothermic event can be determined by comparing DSC measurements of the metal fibers before and after thermal equilibration. In other words, the metal fibers showing such an exothermic event are not in their thermodynamic equilibrium at ambient temperatures. During heating in a DSC measurement, the metal fibers can transit from a metastable to a thermodynamically more stable condition, e.g. by crystallization, recrystallization or other relaxation processes reducing defects in the lattice of metal atoms. An exothermic event observed for the metal fibers when being heated, e.g. during a DSC measurement, indicates that the metal fibers are not in their thermodynamic equilibrium, e.g. the metal fibers can be in an amorphous or nanocrystalline state containing defective energy and/or crystallization energy which is released during heating of the metal fibers due to occurrence of crystallization or recrystallization. Such events can be recognized e.g. using a DSC measurement. It was found that networks of metal fibers which show such an exothermic event have an improved strength after the metal fibers are fixed to one another.

Preferably the metal fibers comprise a non-round cross section, in particular a rectangular, quadratic, partial circular or an elliptical cross section with a large axis and a small axis. Such cross-sections usually lead to fibers which are not in their thermal equilibrium, i. e. in a metastable state, which, for some applications, may be beneficial. Metal fibers obtained by melt spinning show such non-round cross sections and can thereby be distinguished from metal fibers obtained e.g. from bundle drawing.

In this connection it is noted that, obviously, the value of the small axis must be smaller than the value of the large axis. In the case in which the small axis comprises a higher value, i.e. a greater length, than the large axis, the definition of “small” and “large” must simply be interchanged.

It may be preferred that a ratio of the small axis to the large axis lies in the range of 1 to 0.05, preferably in the range of 0.7 to 0.1, in particular in the range of 0.5 to 0.1. As it is generally known, the ratio between the lengths of the small and the large axis of an ellipse is higher the more the ellipse looks like a circle, for which the ratio would be 1. The smaller the value of the ratio is, the flatter is the ellipse. Thus, the ratio of the small axis to the large axis is in particular less than 1.

Alternatively, the metal fibers may comprise a round cross-section. For such a cross-section a ratio of a “large” axis to a “small” axis would obviously be exactly 1. Round cross-sections comprise an energetically more preferred state the cross-sections comprising an aspect ratio that is smaller than 1. Hence, fibers with round cross-sections are energetically closer to their equilibrium state than fibers with cross-sections of other shapes.

Preferably, the metal fibers are obtainable by melt spinning. Preferably, the metal fibers used in the electrode of the present invention are obtainable by subjecting a molten material of the metal fibers to a cooling rate of 10² K·min⁻¹ or higher, in particular by vertical or horizontal melt spinning. Such metal fibers produced by melt spinning can contain spatially confined domains in a high-energy state (i. e. in a metastable state), due to the fast cooling applied during the melt spinning process. Fast cooling in this regard refers to a cooling rate of 10² K·min⁻¹ or higher, preferably of 10⁴ K·min⁻¹ or higher, more preferably to a cooling rate of 10⁵ K·min⁻¹ or higher. By the fast cooling rate, for example by melt spinning, the metal fibers can be obtained in a metastable state, allowing for a higher mechanical strength of a corresponding sintered network of metal fibers.

Also, fibers obtained by melt spinning often comprise a rectangular or semi-elliptical cross section, which are preferred for certain application fields since they are far away from their equilibrium state. Examples for melt spinners with which such fibers can be produced are for example known from the not yet published international application PCT/EP2020/063026 and from published applications WO2016/020493 A1 and WO2017/042155 A1, which are hereby incorporated by reference.

According to another example, at least some of the metal fibers of the plurality of metal fibers are amorphous or at least some of the metal fibers of the plurality of metal fibers are nanocrystalline. Nanocrystalline metal fibers contain crystalline domains. Upon heating to a temperature of about 20-60% of the melting temperature of the nanocrystalline metal fibers, these domains undergo recrystallization resulting in an increase of the average size of crystalline domains compared to the average size of the initial crystalline domains in the nanocrystalline metal fibers before heating. It is also possible to mix non-equilibrated (e.g. nanocrystalline or amorphous fibers) with equilibrated (e.g. annealed) fibers. In the context of the description of the invention “% of the melting temperature” refers to the melting point in ° C. Accordingly, if the melting temperature is e.g. 1000° C., in the context of the description of the invention 20% of the melting temperature is 200° C., 50% of the melting temperature is 500° C. and 95% of the melting temperature is 950° C. The melting temperature may be determined e.g. by DSC measurement.

The network may comprise an average mean pore size selected in the range of 0.1 to 1000 μm, preferably in the range of 0.5 to 500 μm, in particular in the range of 1 to 100 μm. The mean pore size can be determined using a micro-computertomograph to reproduce the fiber structure and then evaluate the mean pore diameter using the bubble point method. The bubble point method determines the largest ball diameter, which might fit between two fibers, which is considered the pore size. More in detail, a point is placed at the center between two fibers and the radius of the bubble, with the point as a center is increased, until contact to the surface of both fibers is made. The diameter of the bubble corresponds to the pore size. If at any given parameter the bubble diameter only contacts one fiber, the center point is displaced into the direction of the fiber that the bubble did not contact.

It is particularly preferable if the three-dimensional network of metal fibers comprised in the electrode according to the invention are fixed, in particular directly fixed, to one another at points of contact which are preferably randomly distributed throughout the network of metal fibers. According to another inventive aspect, it is preferred that the points of contact are not randomly distributed but are provided e.g. in a peripheral region of the network of metal fibers or that the metal fibers are ordered so that also the point of contacts are ordered.

It is further preferred that the points of contact at which the metal fibers are fixed to one another are localized in specific areas and not provided evenly over the complete network of metal fibers. With the points of contact at which the metal fibers are fixed to one another being present only in separated areas, it is possible that the fibers in-between these areas have a high flexibility while at the same time the mechanical stability and good electrical conductivity is ensured.

Preferably the spatial orientation of the metal fibers is unordered. With an unordered network, always some portions of the metal fibers are oriented in the direction of the ion flux. Thereby ion diffusivity is increased on the surface of the metal fibers, allowing to better exploit the associated effects explained above.

Preferably, the spatial orientation of the metal fibers is at least partially ordered. Accordingly, there is a predominant spatial direction of the metal fibers in one direction. Thereby, the portion of metal fibers being oriented in the direction of the ion flux can be increased, yielding even higher ion diffusivity. Orientation of metal fibers may be achieved, e.g. by carding of the metal fibers, before sintering them to the tree-dimensional network of metal fibers.

Preferably, the density of the points of contact is in a range of 1 mm⁻³ to 5000 mm⁻³. More preferably, the density of the points of contact is in a range of 3 mm⁻³ to 2000 mm⁻³, even more preferably in a range of 5 mm⁻³ to 500 mm⁻³. The density of points of contacts can also be regarded as a crosslinking density between the fibers, since at the points of contact the metal fibers are directly fixed to one another and are in electric contact with one another. With a fiber density of 1 mm⁻³ or higher, in particular 5 mm⁻³ or higher, homogenous distribution of the potential is realized, avoiding detrimental effects, such as high overpotential or creation of local hot areas due to a high resistance. In turn, density of points of contacts of 5000 mm⁻³ or lower, in particular of 2000 mm⁻³ or lower, more particular of 500 mm⁻³ or lower is useful for providing flexibility to the three-dimensional network of metal fibers, so that even rather thick three-dimensional networks, i.e. with a thickness of 100 μm or greater, of 200 μm or greater, of 500 μm or greater, or of 550 μm or greater, or of 600 μm or greater, or of 750 μm, or of 5000 μm or greater, or of 10000 μm or greater, can be deformed, e.g. rolled, without causing the network to break.

In accordance with the present invention, the metal fibers preferably have a thickness and/or width in the range of 0.4 to 150 μm, even more preferably in the range of 0.5 to 50 μm. With lower thicknesses and/or widths of the metal fibers, the surface area relative to the weight of the metal fiber increases, resulting in a further suppression of dendrite growth.

Preferably, the metal fibers have a length of 100 μm or more, in particular of 1.0 mm or more. Preferably, the metal fibers have an aspect ratio of their length to their thickness and/or width in the range of 100 to 1 or more. With such a length and/or aspect ratio, each fiber can have several points of contact with other fibers, allowing for a low electric resistance of the three-dimensional network of metal fibers and simultaneously resulting in a mechanically strong network of metal fibers.

In accordance with the present invention, it is preferable when the three-dimensional network of metal fibers has metal fibers consisting of a copper-silicon alloy, more preferably one having a silicon content of less than 20% weight, and having a thickness and/or width in the range of 0.5 to 50 micron and a high aspect ratio (length/diameter) of 100:1 or higher.

While the present invention is not particularly limited to a specific thickness of the electrode, it is preferable for the three-dimensional network of metal fibers to have a thickness in the range of 50 μm to 5 mm, in particular of 200 μm to 5 mm. Even more preferably, the thickness of the three-dimensional network of metal fibers is in a range of greater than 500 μm, in particular greater than 550 μm, more particular greater than 600 μm, even more particular greater than 750 μm, even further more particular greater than 5000 μm. With the network having such a thickness, it is possible to provide ultrathick electrodes. Due to the fibers being in contact, preferably sintered, to one another, there is direct electrical communication between the fibers, providing a high network conductivity in terms of electric conductivity and ion diffusion. In turn, the local potential is distributed homogenously over the volume of the electrode, reducing overpotentials, formation of hot spots and other phenomena that reduce life time of battery components, such as the electrolyte. Further, ultrathick electrodes provide a high areal capacity and reduce the fraction of inactive components, i.e. also the performance per mass unit of the battery is improved. The thickness of the network is not particularly limited. However, in view of homogenous potential distribution over the whole network, thickness is preferably 5 mm or less, even more preferably 4 mm or less, and even more preferably 3 mm or less.

Preferably, the network conductivity is equal to or greater than 1×10⁵ S/m, in particular equal to or greater than 5×10⁵ S/m, in particular equal to or greater than 1×10⁶ S/m. Such high network conductivity improves homogenous distribution of the local potential, even when the density of the three-dimensional network of metal fibers is low. Network conductivity can be measured using a four-point probe measurer.

It is also preferable that the volume fraction of metal fibers in the three-dimensional network of metal fibers is equal to or greater than 0.075 vol %, in particular equal to or greater than 1.3 vol %, in particular 2.0 vol % or greater. Networks with lower volume fractions may have difficulties to homogenously distribute the local potential, in turn this might result in formation of hot spots and high overpotentials. Accordingly, with the volume fraction of the metal fibers in the three-dimensional network of metal fibers as specified above, battery life can be increased. The volume fraction of metal fibers in the tree-dimensional network of metal fibers can be determined using a micro-computertomograph to reproduce the fiber structure and then evaluate the fraction using the bubble point method described herein. These effects are even more pronounced for thick electrodes, in which the network of metal fibers has a thickness of 200 μm or more.

Preferably, the lithium metal electrode in accordance with the present invention further comprises a lithiophilic agent at least on portions of the metal fibers. The lithiophilic agent is a wetting agent, improving the wettability of the metal fiber surface with lithium. Preferably, the lithiophilic agent comprises at least one transition metal, aluminum or magnesium, in particular a transition metal. Even more preferably, the lithiophilic agent is selected from the group consisting of Sn, ZnO, Al₂O, and MgO. A particularly preferred lithiophilic agent is ZnO. Even though such a lithiophilic agent is not strictly necessary, it may further improve the suppression of dendrite growth and may even facilitate the manufacturing of the lithium metal electrode by supporting the infiltration of lithium into the three-dimensional network of metal fibers. Besides inorganic wetting agents, also organic wetting agents can be used. The organic wetting agents may be branched or unbranched, saturated or unsaturated carboxylic acids having at least 10 carbon atoms, in particular at least 15 carbon atoms, and not more than 30 carbon atoms, in particular not more than 25 carbon atoms. Preferred examples for organic wetting agents are abietic acid and oleic acid.

Instead of or in addition to a lithiophilic agent, it is also preferable that the electrode in accordance with the present invention is obtained or is obtainable by applying an electric voltage across the three-dimensional network of metal fibers while providing metallic lithium on the surface of the metal fibers of the tree-dimensional network of metal fibers. Such an electric voltage provides for an electrical induced wettability of the metal fibers with lithium, thus supporting the formation of homogenous coatings of metallic lithium on the metal fibers. The lithium may be provided in liquid form during the application of the electric voltage, e.g. as a melt. The application of the electric voltage may be necessary only for the first deposition cycle or for subsequent cycles.

Further, the present invention relates to a method of manufacturing a lithium metal electrode, wherein the method comprises the steps of
a) providing a three-dimensional network of metal fibers, wherein the metal fibers are directly in contact to one another, wherein the metal fibers have a thickness and/or width in the range of 0.25 to 200 μm; and
b) providing a layer of metallic lithium on the metal fibers of the three-dimensional network of metal fibers.

For producing the lithium metal electrodes, based on a three-dimensional network of metal fibers, it is required that metallic lithium is infiltrated into the network. This may be achieved by various attempts, such as by pressing metallic lithium into the network or by penetrating the network with lithium in a liquid state, i.e. a melt. Electrodeposition proved difficult, in particular for large scale applications, since no source of lithium is present and the lithium in the electrolyte is consumed, decreasing the overall lithium salt concentration and as such the electrochemical properties of the electrolyte. To overcome this hurdle, metallic lithium needs to be present in the metal fiber network and/or the wettability of the metal fibers should be enhanced, e.g. by lithiophilic agent or by electrowetting, as described above. To achieve this, it was found that lithium can be pressed, e.g. by static or roll-pressing, into the metal fiber network. Lithium metal has a low hardness of only 0.6 Mohs. Pressing the metallic lithium into the network has been proven beneficial to combine the metallic fiber network with the respective lithium metal. Due to the large mechanical stability of the network, especially in comparison with carbon-based networks (CNT-, Graphene- or reduced Grapheneoxide scaffolds), the metal fiber network undergoes no to little deformation upon pressing, e.g. static or roll pressing.

Preferably, the network of metal fibers can be infiltrated with liquid lithium, i.e. molten lithium. To do so, it is further preferable to improve wettability of the metal fibers with liquid lithium by providing a lithiophilic compound or coating on the metal fibers before infiltrating the network with liquid lithium.

It is to be understood that the lithium metal electrode produced by the method of the present invention is one in accordance with the present invention, i.e. one as described above and/or in the appended claims. All aspects set out above for the electrode of the present invention, apply also to the method of the present invention of manufacturing a lithium metal electrode.

Preferably, step a) includes the production of metal fibers by melt spinning, in particular by subjecting a molten material of the metal fibers to a cooling rate of 10² K min⁻¹, preferably of 10⁴ K·min⁻¹ or higher, more preferably to a cooling rate of 10⁵ K·min⁻¹ or higher, in particular by vertical or horizontal melt spinning. As set out above, thereby metal fibers in a metastable state can be obtained, allowing for a mechanically stronger network which may be advantageous when pressing the lithium metal into the network.

Further, it is preferable that in the method of the present invention step a) includes the dispersion of the metal fibers in a liquid, sedimentation of the metal fibers, and sintering the metal fibers to one another. Formation of the metal fiber network may be achieved for example as described in WO 2020/016240 A1 which is herewith incorporated by reference in its entirety. The resulting network is highly mechanically stable, whilst providing at the same time a large inherent surface.

Further, the present invention concerns a lithium ion battery, comprising an anode electrode, which is a lithium metal electrode according to claim 1. It is to be understood that the lithium metal battery of the present invention is one including an anode electrode, which is a lithium ion electrode in accordance with the present invention, i.e. one as described above and/or in the appended claims. All aspects set out above for the electrode of the present invention and/or for the method of manufacturing a lithium metal electrode, apply also to the method of the present invention of manufacturing a lithium metal electrode.

The cathode used in the battery of the present invention is not particularly limited. However, it is preferable when the battery according to the present invention further comprises a cathode, comprising a network of metal fibers, in particular a three-dimensional network of metal fibers, wherein the metal fibers consist of aluminum or of an aluminum alloy. By utilizing a thick fiber based cathode, a high amount of cathode active material can be incorporated into the battery, allowing for a complete exploitation of the lithium incorporated into the network structure of the anode. Thereby a high capacity can be achieved. In this regard it is noted that the details described herein for the network of metal fibers of the anode electrode, i.e. the lithium-metal based electrode of the present invention, apply equally to the three-dimensional network of metal fibers of the cathode, wherein the preferred material for the cathode electrode is aluminum or an aluminum alloy.

For the active cathode material, any suitable material may be used. Preferably, the active material for the cathode is selected from the group consisting of Lithium-Nickel-Manganese-Cobalt-Oxide (NMC), Lithium-Nickel-Cobalt-Aluminium-Oxide (NCA), Lithium-Cobalt-Oxide (LiCoO2) and Lithium-Iron-Phosphate (LFP).

Preferably, in step b) the layer of metallic lithium is provided on the metal fibers by placing first a portion of metallic lithium on the three dimensional network of metal fibers and subsequently applying pressure onto the metallic lithium provided on the three-dimensional network of metal fibers to press the metallic lithium into the open structures of the three-dimensional network of metal fibers. This is a rather simple way of introducing the lithium into the network structures, making use of the low hardness of lithium.

It is further preferable that in step b) of the method of the present invention before providing the layer of metallic lithium on the metal fibers a lithiophilic coating is provided on the metal fibers. In particular for applying the lithium in a liquid form, this enhances the wettability of the metal fibers. However, also when pressing the lithium in solid state into the network structure, the lithiophilic agent may have advantageous effects, especially during cycling of the corresponding battery.

As set out above for the lithium metal electrode of the present invention, the lithiophilic agent preferably comprises at least one transition metal, tin, aluminum or magnesium, in particular a transition metal. Even more preferably, the lithiophilic agent is selected from the group consisting of Sn, ZnO, Al₂O, and MgO. A particularly preferred lithiophilic agent is ZnO or Sn, more preferably ZnO. Even though such a lithiophilic agent is not strictly necessary, it may further improve the suppression of dendrite growth and may even facilitate the manufacturing of the lithium metal electrode by supporting the infiltration of lithium into the three-dimensional network of metal fibers. Besides inorganic wetting agents, also organic wetting agents can be used. The organic wetting agents may be branched or unbranched, saturated or unsaturated carboxylic acids having at least 10 carbon atoms, in particular at least 15 carbon atoms, and not more than 30 carbon atoms, in particular not more than 25 carbon atoms. Preferred examples for organic wetting agents are abietic acid and oleic acid.

In the method of the present invention, it is preferable to provide in step b) the layer of metallic lithium on the metal fibers while applying an electric voltage across the tree-dimensional network of metal fibers. Thereby an electrowetting may be achieved, as described above. The electric voltage can be applied for the first deposition cycle only or for every deposition cycle of one or more subsequent deposition cycles.

Further, the present invention concerns an electric machine comprising a battery according to the present invention. In particular, the battery in accordance with the present invention provides power to a circuit of the electric machine. Further, it is preferable that the circuit of the electric machine provides power to a motor for propelling the electric machine, in particular an electric vehicle.

The invention will now be described in further detail and by way of example only with reference to the accompanying drawings and figures as well as by various examples of the network and method of the invention. In the drawings there are shown:

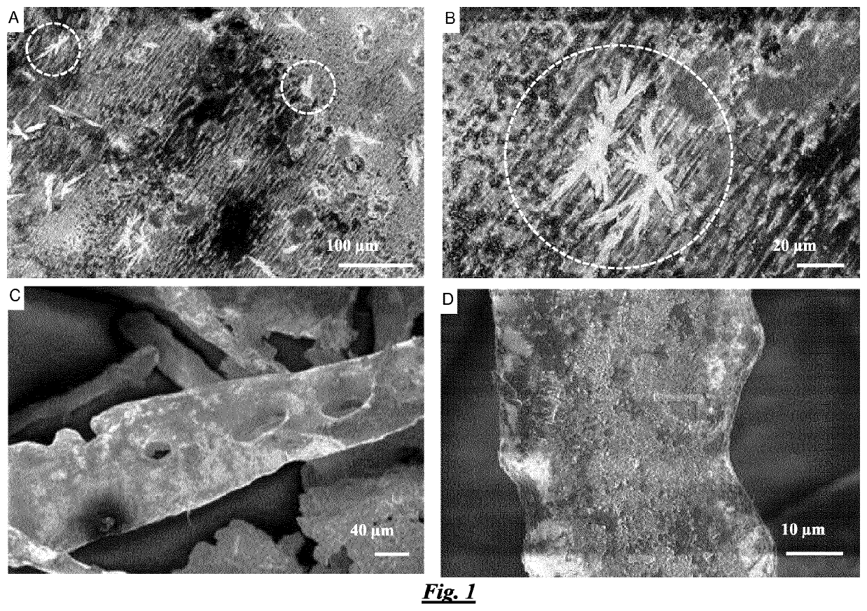

FIG. 1a) Scanning electron microscope image showing dendrite formation on a copper foil.

FIG. 1b) Further enlarged scanning electron microscope image from the sample of FIG. 1a)

FIG. 1c) Scanning electron microscope image showing homogenous coating of metallic lithium on a metal fiber of a three dimensional network of metal fibers of a lithium metal electrode according to the present invention.

FIG. 1d) Further enlarged scanning electron microscope image from the sample of FIG. 1c)

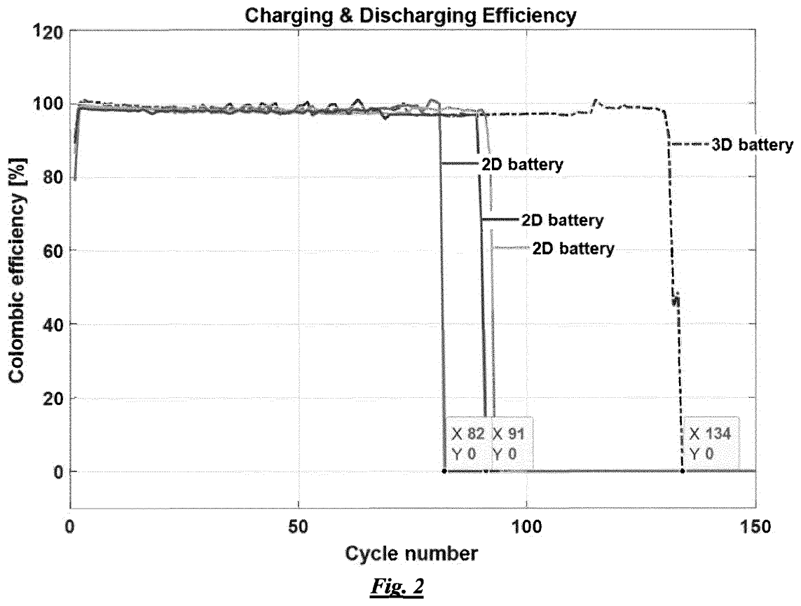

FIG. 2 Graph showing a comparison of coulombic efficiency for three samples of a lithium metal battery having a copper foil as anode electrode and for one sample having a three dimensional network of metal fibers as an electrode in accordance with the present invention.

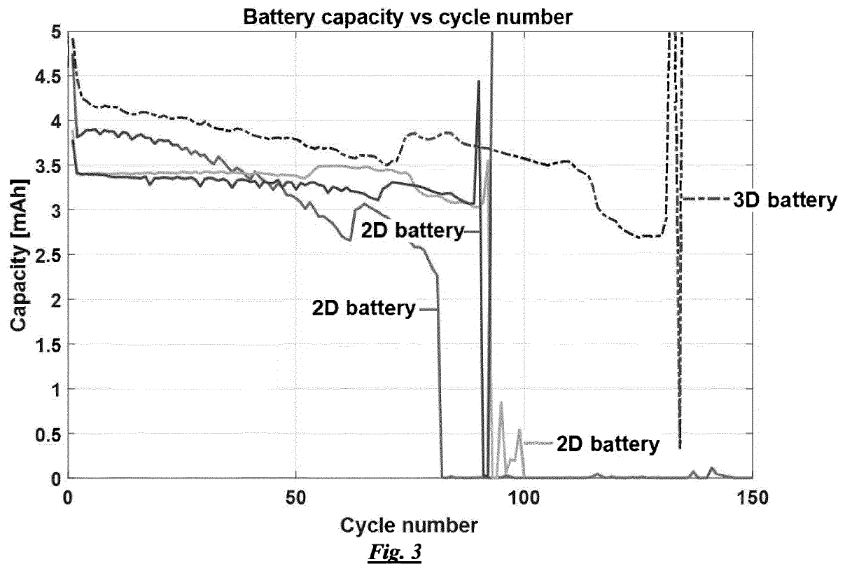

FIG. 3 Graph showing the development of the battery capacity over the cycle numbers for the same samples as shown in FIG. 2.

FIG. 4 Two graphs, showing comparisons of the charge/discharge profiles of a copper foil electrode and for an electrode made of a three dimensional network of metal fibers, one graph shows the first cycle, the other graph the fiftieth cycle.

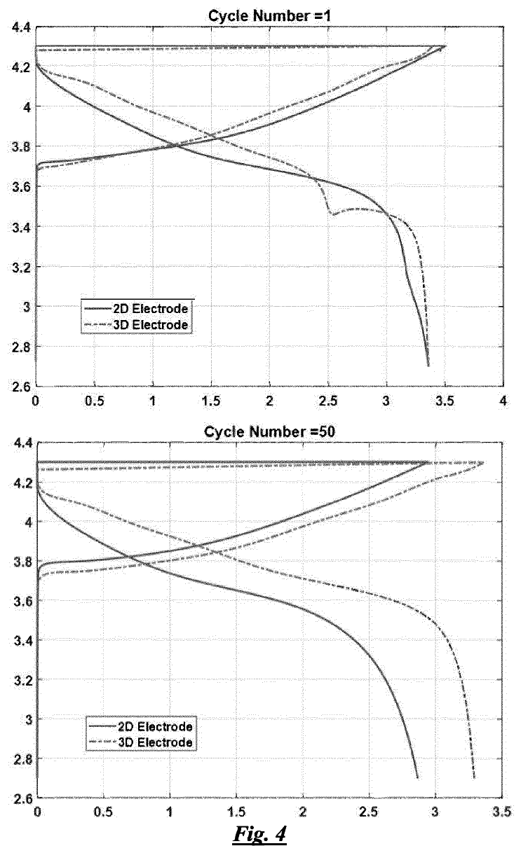

FIG. 5 Testing and Control setup for a lithium metal-based anode tested in a CR 2032 coil cell assembly, wherein the testing setup corresponds to the present invention.

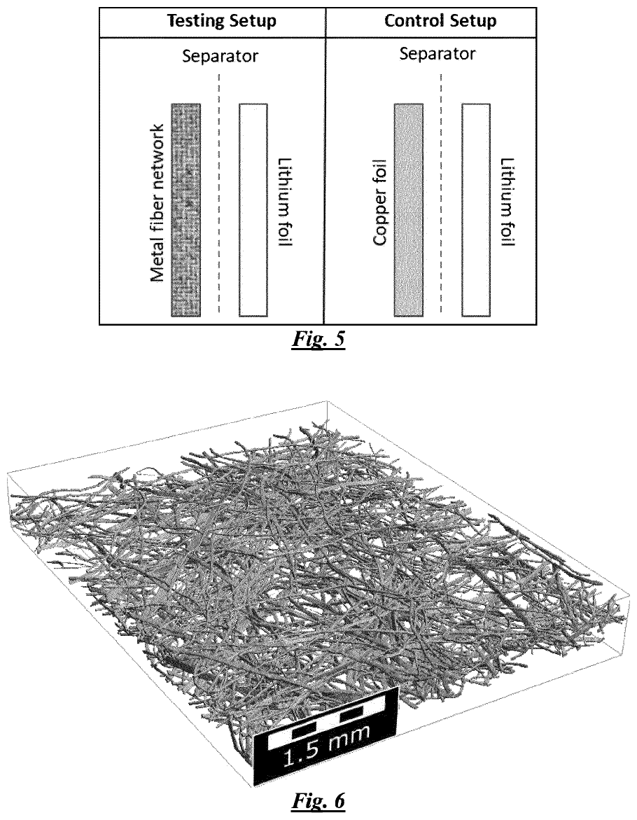

FIG. 6 Microcomputer tomographic image of a three-dimensional network of metal fibers, for use in an electrode according to the present invention.

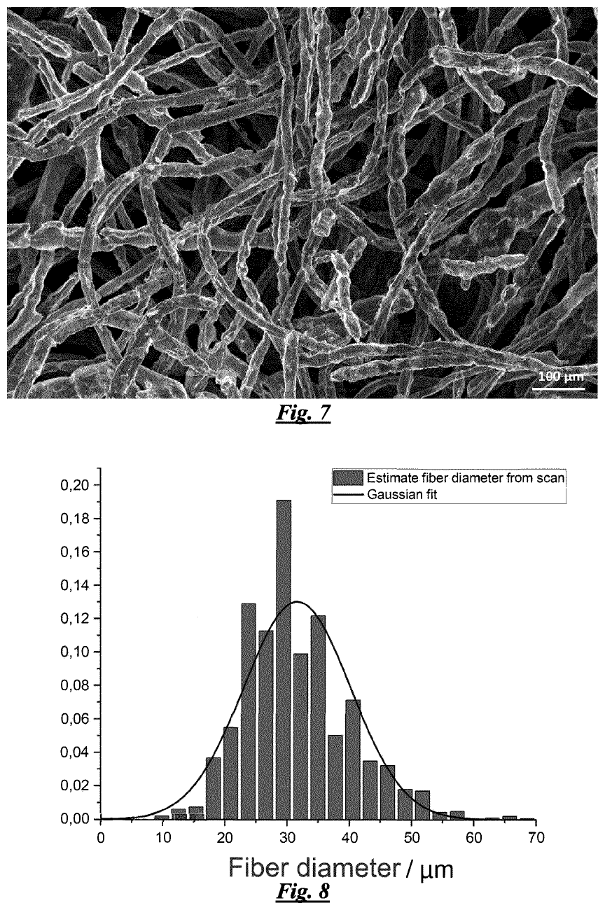

FIG. 7 Scanning electron microscope image showing the structure of a three-dimensional network of CuSi4 fibers, sintered to one another.

FIG. 8 Fiber diameter distribution of a three-dimensional network of metal fibers for an electrode according to the present invention.

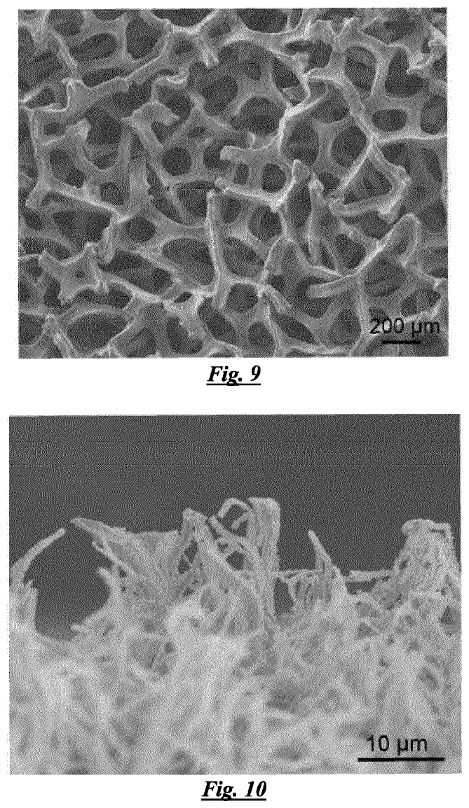

FIG. 9 Scanning electron microscope image showing the structure of a three-dimensional copper foam, as used for comparative purposes.

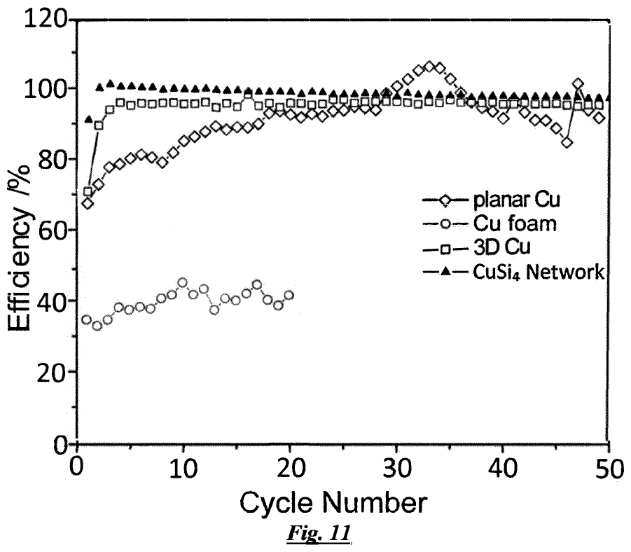

FIG. 10 Scanning electron microscope image showing a side view of a copper foil having porous structures on its surface, wherein the porous structures were obtained by reducing Cu(OH)₂ to metallic copper whiskers on the surface of a copper foil.

FIG. 11 Graph showing a comparison of coulombic efficiency for three comparative examples (squares, diamonds, and circles) and an example (triangles) according to the invention.

### RESULTS & DISCUSSION

### Morphology of Electrodeposited Lithium on a 2D Vs 3D Electrodes in Liquid Electrolyte:

In order to directly compare the formation of dendrites (or the absence of them) in cells composed of a metal fiber network electrode or a 2D metal foil electrode, half-cells comprising of a lithium foil and the metal counter electrode were fabricated. To deposit lithium onto the metal current collector, a negative current vs the counter electrode (pure Li-foil) is applied and lithium is electrochemically transferred from the lithium foil to the current collector. As shown in FIG. 1a, 1b, the formation of lithium dendrite on a copper foil can be easily observed and is marked by a white circle.

However, in case of a metal fiber network FIG. 1c, 1d, the deposition rate per areal unit is much lower than in case of the metal foil, since the network has a significantly large surface area and the current for both electrodes (2D and 3D electrode) is constant. Thus, the larger surface leads to lower lithium deposition rate per areal unit. The comparison between the 3D network and the 2D counterpart is quite obvious, since no dendrites could be observed on the fibrous network. Additionally, both the networks material composition and its morphology differ greatly from the foil, since the networks material is 96 wt % Cu and 4 wt % Si and it is present in the form of fibers. For testing the influence of the metal composition in detail this behavior in detail, a foil made of Cu₉₆Si₄ was fabricated, subsequently tested and the dendrite growth investigated.

Pressing Lithium into the Metal Fiber Network:

In order to fabricate full cells, the metallic lithium needs to be infiltrated into the metal fiber network before assembly of the electrochemical cell. In order to deposit lithium into the metal fiber network, the technique electrodeposition proved unsuccessful, since no source of lithium is present and the lithium in the electrolyte is consumed, decreasing the overall lithium salt concentration and as such the electrochemical properties of the electrolyte. To overcome this hurdle, metallic lithium needs to be present in the metal fiber network. Roll-pressing was used to deposit Lithium into the metal fiber network. Roll-pressing of lithium metal, which has a very low hardness of 0.6 Mohs, has been proven beneficial to combine the metallic fiber network with the respective lithium metal. Due to the large mechanical stability of the network and in comparison, with carbon-based networks (CNT-, graphene- or reduced graphene oxide scaffolds) the metal fiber network undergoes no to little deformation upon roll pressing.

In order to investigate the roll pressed lithium and copper silicon network, a full cell is built upon this and with NMC cathode material. In order to compare the performance of the lithium-filled network against the lithium metal foil, the coulombic efficiency is shown in FIG. 2. As it is observed from FIG. 2, the 2D Li-metal foil anode based cells show a dramatic decrease in performance after 82-91 cycles, whereas their 3D metal fiber-based counterpart, i.e. using an electrode according to the present invention, is stable up to 134 cycles, resulting in a 50% increase in cyclic performance. The cell collapse occurs due to the growth of a dendrite along the concentration gradient leading to penetration of the separator. Subsequently, an electrical connection between anode and cathode is formed and an internal short circuit leads to inoperability of the electrodes.

As displayed in FIG. 3, in comparison between the Li-metal and CuSi-network/Li-metal anodes, the CuSi-network based electrode leads to a boost in capacity, due to the greatly enhanced surface area and more of the lithium can be deposited faster. Additionally, this leads to less dendrite growth, since per surface area less lithium is deposited.

However, the CuSi-network does not only have an influence on the overall cyclic performance of the network, but also the deposition mechanism and the related overpotential. The potential at which lithium deposition occurs in an electrochemical cell is usually given by the intercalation voltage of an electrode, e.g. for graphite between 0.1 V and 0.4 V or for LiNiMnCoO2 (NMC) between 3.5 V and 4 V. However, since the intercalation rate is limited, meaning that only a certain number of Li-ion can be intercalation into a certain volume of active material in a given time frame, higher charging rates lead to overpotentials. Not only are these overpotential observed during different charging rates, but also because of ageing of the electrolyte. In this case the decomposition of the electrolyte, due to the higher applied voltages, leads to the growth of the solid electrolyte interface (SEI), which decreases the speed at which the Li-Ions are transported to the active material drastically. Thus, the overpotential measured during a constant charge/discharge profile is also a method to evaluate the electrochemical stress enacting upon the electrode. As can be easily observed in FIG. 4 a similar overpotential is observed for the charging profile (from 3.6 to 4.4 V), during which Lithium is deposited onto the metallic anode. However, already during the 1^{st} cycle, a larger overpotential is observed, during the discharge phase (from 4.4 to 3.6) during which metallic lithium is stripped from either the foil of the CuSi network. This effect becomes even more pronounced during the 50^{th} cycle, leading to greatly increased overpotentials during charging and discharging. Since the overpotential (and its energy, given by current multiplied by voltage) is directly converted into heat and lost during the storage process, lower overpotentials are highly beneficial.

In summary, the 3D metal fiber-based electrode of the present invention is able to boost life time and the capacity of a lithium metal based full cell. Additionally, the heat formation during the charging/discharging process is highly related to the overpotentials applied during the respective process. This means, that faster charging leads to more heat and older cells generally produce also more heat. This effect could be highly decreased by using a 3D CuSi fiber network as metal backbone for the Li-metal deposition. Especially during the metal stripping process, the overpotential is significantly lower compared to the Li-metal foil. This allows for faster charging and discharging rates, probably because the number of lithium ions depositable in a specific time window is increased due to the large inner surface of the metal fiber network.

### Materials:

In order to fabricate a metal fiber network, melt-spun fibers, as described in as described for example in WO 2020/016240 A1 have been utilized. These metal fibers have been sintered at 980° C. with the aim to obtain a connected network. From the network, several electrodes with a diameter of 14 mm have been punched out. The resulting metal fiber network has been utilized without any further treatment as anode scaffold in the electrochemical cells. As counter electrode, pure metallic lithium (Alfa Aesar, 99.95%) was used if not indicated otherwise. For the infiltration of lithium, the same lithium quality has been used.

### Electrochemistry:

The metal fiber network that was also used for the inventive Example described in the following and a copper foil were used as current collectors against a lithium metal foil. In order to construct a coin cell (CR2032), the foil and the metal fiber network were punched out at a diameter of 14 mm. As separator a Whatman AH Grade 680 glas fiber filter was applied, whereas as counter electrode a disc of metallic lithium with a diameter of 15.6 mm was used. Thus, the experiment was designed according to the schematic drawing of FIG. 5.

In order to deposit metallic lithium onto a copper foil or into a metal fiber network, a negative current was applied between both contacts. Upon application of a negative current, metallic lithium is deposited onto the contact on which a negative current is applied according to Reaction 1.

Li⁺+e⁻→Li^{metallic} [1]

A current of 0.5 mA, 1 mA and 2 mA was applied for 2 hours, resulting in a deposited capacity of 1 mAh, 2 mAh and 4 mAh, respectively. The deposited lithium was then completely stripped at the same current rate with a voltage limitation of 1V.

In the following a comparison of the performance of batteries based on different electrode materials is described.

### EXAMPLE

As an electrode in accordance with the present invention, a sintered three-dimensional network of metal fibers was prepared, as described in WO 2020/016240 A1. The material of the metal fibers was CuSi4, i.e. it is an alloy of copper and silicon, consisting of 96 wt. % copper and 4 wt. % silicon. A micro computertomographic image of the network used for the electrode is shown in FIG. 6 and a scanning electrone microscopic image thereof is shown in FIG. 7. It can be recognized that the individual fibers are directly sintered to one another, without the use of any further additive, such as binder or solder. The fiber thickness is a term that is when describing the present invention interchangeably used with the term fiber diameter. The fiber thickness of the fibers of the three-dimensional network is around 31 μm, as can be recognized from the gaussian fit shown in FIG. 8. FIG. 8 shows the fiber diameters as estimated from a scan with a micro-computertomograph (micro-CT) and a gaussian fit. In accordance with the present invention, the fiber thickness is determined by estimating the fiber diameters of fibers by micro-CT measurement and making a gaussian fit based on the estimated fiber diameters. The fiber thickness, as referred to herein, corresponds to the maximum of the gaussian fit.

For producing a network in accordance with the present invention, a circular sample of suitable size was stamped out of the sintered network of metal fibers. The sample was than infiltrated with lithium by roll pressing metallic lithium into the sintered network. Full cells were built, with a Li-filled metal fiber network and NMC as an active material counterpart on the cathode electrode.

### Comparative Examples

For comparative reasons, further lithium metal anode electrodes and corresponding lithium metal batteries were prepared, as described above. However, instead of a three-dimensional network of sintered metal fibers, a planar copper foil, a copper foam and a copper foil having porous structures obtained by reducing Cu(OH)₂ to metallic copper whiskers on the surface of a copper foil were used.

The copper foam was obtained from Xiamen Zopin New Material Limited Room 602-1, 39 Xinchang Road, Haicang District, Xiamen City, Fujian Province, China. A scanning electron microscope image of the copper foam is shown in FIG. 9.

The copper foil having porous structures obtained by reducing Cu(OH)₂ to metallic copper whiskers on the surface of a copper foil was prepared following the procedure of Luo et al.¹⁹ and Guo et al.²⁰. A scanning electron microscope image of the copper whiskers on the surface of the copper foil is shown in FIG. 10.

The planar copper foil, the copper foam and the copper foil having porous structures were used with lithium metal as lithium metal anodes in full cells as described for the Example above. For doing so, the copper foil, copper foam and copper foil having porous structures were loaded with metallic lithium by static pressing or electrochemical plating.

The following table 1 shows an overview of characteristics of the electrodes of the comparative Examples and of the Example in accordance with the present invention.

TABLE 1

| | | Comparative Examples | | | Example |
|---|---|---|---|---|---|
| | | Planar | Cu | Porous | CuSi₄ fiber |
| Electrode base material | | Cu foil | Foam | Cu foil | network |
| Areal Density | mg cm⁻² | 21.8 | 6.93 | 19.4 | 15 |
| Median Pore size | μm | — | 170 | 2.1 | 176 |
| Specific pore volume | cm³ g⁻¹ | — | 0.58 | 0.075 | 0.6231 |
| Areal pore volume | 10⁻³ cm³ cm⁻² | — | 4 | 1.5 | 2.0 |

A comparison of the coulombic efficiency over 50 cycles is shown in FIG. 11. Data points obtained for an electrode based on a planar copper foil are indicated by diamonds (Comparative Example). Data points obtained for an electrode based on a copper foam are indicated by circles (Comparative Example). Data points obtained for an electrode based on a porous copper foil are indicated by squares (Comparative Example). Data points obtained for an electrode based on a three-dimensional network of sintered metal fibers are indicated by triangles (Example in accordance with the invention).

The electrode of the Example above is in accordance with the present invention and reaches a very high efficiency already in the second cycle and maintains this value sable over far more than 100 cycles, as indicated by the triangles in FIG. 11 and by the measurement results of FIG. 2. In contrast, the comparative example using a planar copper foil has a much more unstable behavior, before reaching a high number of cycles and suffers from dendrite growth, which can be recognized from FIGS. 1a and 1b. Further, the dendrite growth finally results in an internal short circuit after around 90 cycles, as can be recognized from FIG. 2. In contrast, the electrode of the present invention does not suffer from dendrite growth, as can be recognized from FIGS. 1c and 1d.

A comparison between the inventive Example and the copper foam shows a much lower efficiency for the foam structure-based electrode. This is assumed to be related to the formation of dead lithium in the foam structure, whereas the metal fiber-based structures do not show formation of such dead lithium.

Regarding the porous copper foil, also a relatively high efficiency could be observed for the charging/discharging cycles, as can be recognized from the squares in FIG. 11. Nevertheless, the efficiency remains lower than for the metal fiber-based electrode of the inventive Example. Further, the electrode of the inventive example exhibits a lower overpotential compared to the porous fiber electrode, indicating that during charging/discharging, less electrochemical stress is generated on the cell components. This suggests that longer life times can be achieved and less electrolyte decomposition occurs.

### REFERENCES

1. Ghazi, Z. A. et al. Key Aspects of Lithium Metal Anodes for Lithium Metal Batteries. Small 15, 1900687 (2019).
2. Liu, B., Zhang, J.-G. & Xu, W. Advancing Lithium Metal Batteries. Joule 2, 833-845 (2018).
3. Liu, J. et al. Pathways for practical high-energy long-cycling lithium metal batteries. Nat Energy 4, 180-186 (2019).
4. Yoshino, A., Sanechika, K. & Nakajima, T. Secondary battery. (1987).
5. Xu, W. et al. Lithium metal anodes for rechargeable batteries. Energy Environ. Sci. 7, 513-537 (2014).
6. Tarascon, J.-M. & Armand, M. Issues and challenges facing rechargeable lithium batteries. Nature 414, 359-367 (2001).
7. Whittingham, M. S. Lithium Batteries and Cathode Materials. Chem. Rev. 104, 4271-4302 (2004).
8. Fang, C., Wang, X. & Meng, Y. S. Key Issues Hindering a Practical Lithium-Metal Anode. Trends in Chemistry 1, 152-158 (2019).
9. Fang, C. et al. Quantifying inactive lithium in lithium metal batteries. Nature 572, 511-515 (2019).
10. Guo, Y., Li, H. & Zhai, T. Reviving Lithium-Metal Anodes for Next-Generation High-Energy Batteries. Advanced Materials 29, 1700007 (2017).
11. Zhang, S. S. Problem, Status, and Possible Solutions for Lithium Metal Anode of Rechargeable Batteries. ACS Appl. Energy Mater. 1, 910-920 (2018).
12. Shim, J. et al. 2D boron nitride nanoflakes as a multifunctional additive in gel polymer electrolytes for safe, long cycle life and high rate lithium metal batteries. Energy & Environmental Science 10, 1911-1916 (2017).
13. Zhou, W. et al. Plating a Dendrite-Free Lithium Anode with a Polymer/Ceramic/Polymer Sandwich Electrolyte. J. Am. Chem. Soc. 138, 9385-9388 (2016).
14. Qian, J. et al. Lithium Induced Nano-Sized Copper with Exposed Lithiophilic Surfaces to Achieve Dense Lithium Deposition for Lithium Metal Anode. Advanced Functional Materials 31, 2006950 (2021).
15. Wang, W., Hao, F. & Mukherjee, P. P. Mechanistics of Lithium-Metal Battery Performance by Separator Architecture Design. ACS Appl. Mater. Interfaces 12, 556-566 (2020).
16. Jin, S., Jiang, Y., Ji, H. & Yu, Y. Advanced 3D Current Collectors for Lithium-Based Batteries. Advanced Materials 30, 1802014 (2018).
17. Nieto, A., Boesl, B. & Agarwal, A. Multi-scale intrinsic deformation mechanisms of 3D graphene foam. Carbon 85, 299-308 (2015).
18. Lu, Q. et al. Dendrite-Free, High-Rate, Long-Life Lithium Metal Batteries with a 3D Cross-Linked Network Polymer Electrolyte. Advanced Materials 29, 1604460 (2017).
19. Lu, L.-L. et al. Free-Standing Copper Nanowire Network Current Collector for Improving Lithium Anode Performance. Nano Lett. 16, 4431-4437 (2016).
20. Guo, F. et al. Flaky and Dense Lithium Deposition Enabled by a Nanoporous Copper Surface Layer on Lithium Metal Anode. ACS Materials Lett. 2, 358-366 (2020).
21. Ruffo, R., Hong, S. S., Chan, C. K., Huggins, R. A. & Cui, Y. Impedance Analysis of Silicon Nanowire Lithium Ion Battery Anodes. J. Phys. Chem. C 113, 11390-11398 (2009).
22. Polat, B. D. & Keles, O. The effect of copper coating on nanocolumnar silicon anodes for lithium ion batteries. Thin Solid Films 589, 543-550 (2015).

1-59. (canceled)

60. Lithium metal electrode, comprising
a three-dimensional network of metal fibers, wherein the metal fibers are directly in contact to one another, wherein
the metal fibers have a thickness and/or width in the range of 0.25 to 200 μm, and wherein metallic lithium is provided on the surface of the metal fibers of the tree-dimensional network of metal fibers.

61. Lithium metal electrode according to claim 60,
wherein the metal fibers are sintered to one another without an additional binder and/or solder.

62. Lithium metal electrode according to claim 60,
wherein the metal fibers are of copper, nickel, tin a copper alloy, or a nickel alloy.

63. Lithium metal electrode according to claim 60,
wherein the metal fibers consist of a copper alloy which consists of copper and silicon.

64. Lithium metal electrode according to claim 60,
wherein the metal fibers comprise a non-round cross section.

65. Lithium metal electrode according to claim 60,
wherein the three-dimensional network of metal fibers has a thickness in the range of 50 μm to 5 mm.

66. Lithium metal electrode according to claim 60,
wherein the thickness of the three-dimensional network of metal fibers is in a range of greater than 500 μm.

67. Lithium metal electrode according to claim 60,
wherein the spatial orientation of the metal fibers is unordered.

68. Lithium metal electrode according to claim 60,
wherein the metal fibers are directly sintered to one another at points of contact between the metal fibers.

69. Lithium metal electrode according to claim 60,
wherein the fibers have at least on portions of their surface a lithiophilic agent.

70. Lithium metal electrode according to claim 69,
wherein the lithiophilic agent comprises at least one transition metal, tin, aluminum or magnesium.

71. Lithium metal electrode according to claim 69,
wherein the lithiophilic agent is a carboxylic acid.

72. Method of manufacturing a lithium metal electrode, wherein the method comprises the steps of
a) providing a three-dimensional network of metal fibers, wherein the metal fibers are directly in contact to one another, wherein the metal fibers have a thickness and/or width in the range of 0.25 to 200 μm; and
b) providing a layer of metallic lithium on the metal fibers of the three-dimensional network of metal fibers.

73. Method according to claim 72,
wherein the lithium metal electrode comprises
a three-dimensional network of metal fibers, wherein the metal fibers are directly in contact to one another, wherein
the metal fibers have a thickness and/or width in the range of 0.25 to 200 μm, and
wherein metallic lithium is provided on the surface of the metal fibers of the three-dimensional network of metal fibers.

74. Method according to claim 72,
wherein step a) includes the production of metal fibers by melt spinning.

75. Method according to claim 72,
wherein in step b) the layer of metallic lithium is provided on the metal fibers by placing first a portion of metallic lithium on the three dimensional network of metal fibers and subsequently applying pressure onto the metallic lithium provided on the three-dimensional network of metal fibers to press the metallic lithium into the open structures of the three-dimensional network of metal fibers.

76. Method according to 72,
wherein in step b) before providing the layer of metallic lithium on the metal fibers a lithiophilic coating is provided on the metal fibers.

77. Method according to any of claim 76,
wherein the lithiophilic agent comprises at least one transition metal, tin, aluminum or magnesium.

78. Method according to claim 76,
wherein the lithiophilic agent is a carboxylic acid.

79. Method according to claim 72,
wherein in step b) the layer of metallic lithium is provided on the metal fibers while applying an electric voltage across the tree-dimensional network of metal fibers.

80. Method according to claim 72,
wherein the electric voltage is applied for the first deposition cycle only.

81. Method according to claim 72,
wherein the electric voltage is applied for further deposition cycles or every deposition cycle of further subsequent lithium deposition cycles.

82. Lithium ion battery, comprising as an anode a lithium metal electrode, the Lithium metal electrode comprising
a three-dimensional network of metal fibers, wherein the metal fibers are directly in contact to one another, wherein the metal fibers have a thickness and/or width in the range of 0.25 to 200 μm, and
wherein metallic lithium is provided on the surface of the metal fibers of the three-dimensional network of metal fibers.

83. Battery according to claim 82,
wherein the battery further comprises a cathode, comprising a network of metal fibers, wherein the metal fibers consist of aluminum or an aluminum alloy.

84. Electric machine, comprising a lithium ion battery the lithium ion battery comprising as an anode a lithium metal electrode, the Lithium metal electrode comprising
a three-dimensional network of metal fibers, wherein the metal fibers are directly in contact to one another, wherein the metal fibers have a thickness and/or width in the range of 0.25 to 200 μm, and
wherein metallic lithium is provided on the surface of the metal fibers of the three-dimensional network of metal fibers.

85. Electric machine according to claim 84, wherein the electric machine is an electric vehicle.

86. Lithium metal electrode according to claim 64,
wherein the metal fibers comprise an elliptical cross-section having a large axis and a small axis.
